(19) United States
(12) Patent Application Publication
(10) Pub. No.: US 2016/0187646 A1
(43) Pub. Date: Jun. 30, 2016

(54) HIGH-SPEED OPTICAL SCANNING SYSTEMS AND METHODS

(71) Applicant: Jonathan S. Ehrmann, Sudbury, MA (US)

(72) Inventor: Jonathan S. Ehrmann, Sudbury, MA (US)

(21) Appl. No.: 14/983,446

(22) Filed: Dec. 29, 2015

Related U.S. Application Data
(60) Provisional application No. 62/097,183, filed on Dec. 29, 2014.

(51) Int. Cl. G02B 26/10; B23K 26/082; G02B 27/00

(52) U.S. Cl. CPC G02B 26/101; G02B 26/105; G02B 27/0031; G02B 27/0068; B23K 26/082

(57) ABSTRACT

Relay-based laser scanning systems and methods direct a converging input beam to a scanned output beam. A first beam deflector scans an image associated with the converging input along an arcuate intermediate image locus. A relay optic images the clear aperture of the first beam deflector to a second beam deflector and reimages the intermediate image from an internal conjugate distance to an external conjugate distance. Systems and methods may include an converging optic that converges the input to an image at the intermediate image locus. The converging optic may correct optical aberrations of the relay optic. The converging optic may be translated to change the radius of the intermediate image locus and vary the external conjugate distance. A scan head may have low inertia galvo-based scan mirrors. A controller may direct the scanned beam to predetermined points in a scan field. Material may be processed at multiple heights.

### CROSS-REFERENCE TO RELATED APPLICATIONS

This application claims the benefit of U.S. provisional application Ser. No. 62/097,183, filed Dec. 29, 2014, entitled “HIGH-SPEED OPTICAL SCANNING SYSTEMS AND METHODS.”

### BACKGROUND OF THE INVENTION

The field of the invention is high-speed laser scanning.

Lasers are widely used in a variety of applications with optics to focus the laser beam to a spot at the workpiece. Many systems employ optical scanners to direct the laser beam to locations within a scan field at high speed. Some optically scanned systems, utilize rotating mirrors mounted on galvanometers (galvos) for high-speed precision laser scanning. A pair of galvos is mechanically mounted into a scan head to deflect the beam in two axes. Typically, a controller associated with the scan head is used to generate analog or digital positioning signals that control the galvo angles and resulting mirror rotation to direct the beam to positions in the scan field.

These galvo-based systems typically use optics such as pre-objective scan lenses or post-objective scan lenses when a focused spot is required. FIGS. 1A and 1B show the basic configurations of pre-objective and post-objective scanning respectively. Referring to FIG. 1A, the pre-objective type deflects an input laser beam with scan head 100 before it impinges scan lens objective 101. Then, after deflection by scan head mirrors, the objective directs the beam to x and y axes coordinate locations in the scan field and at the same time the objective focuses the laser to a spot in the scan field. F-theta lenses are a well-known class of flat-field pre-objective scan lenses that form a spot in a flat scan field at a position such that the position of the laser spot in the field is proportional to the input scan angle. The f-theta lenses are well-suited for use with small aperture galvo mirrors, and can form a compact high-speed beam positioning system. Unfortunately, f-theta lenses are generally fixed focus lenses with no provision for focus accommodation to vary the distance from scanners to the scan field.

In a different optical arrangement, referring to FIG. 1B, post-objective scan lens systems deflect the beam with rotating scan head mirrors of scan head 100 after the beam exits upstream focusing optics 102. This arrangement is well-suited to larger beam diameters where f-theta lenses become relatively costly and complex. To focus on a flat field, post-objective systems use some form of dynamic focusing to accommodate focus distance changes at different positions in the scan field. Utilizing predetermined scan head geometry and scan field locations, dynamic focusing can be controlled to flatten the scan field of the post-objective system. With a dynamic focus z-axis in addition to x and y field scanning, the post-objective system is known as a 3-axis system, deflecting the beam in the x-axis, the y-axis, and dynamically focusing along the z-axis. Dynamic focusing usually relies on mechanical lens translation. Translation speeds are slow when compared with high-speed galvo beam deflection speeds, so post-objective dynamic focusing is not well-suited to high-speed scanning.

In certain applications, it is desirable to rapidly focus the laser spot on non-planar surfaces, for example, scanning on inclined planes, cylindrical surfaces or other surfaces as may be found in pharmaceutical packaging, firearm parts and other items. Methods for accomplishing non-planar focusing include control of dynamic focus systems either configured as post-objective scan optics or as dynamic input beam collimators to vary the input divergence to an f-theta lens. Both systems involve long optical systems with multiple lens groups upstream of the laser scan head, usually one or more dynamic lens element and a static objective or collimating lens.

Among many criteria of interest in laser scanning heads are scanning speed, focusing ability and compact size. With regard to scanning speed, small low-inertia scan mirrors and optimized scan mirror geometry are used to minimize mirror inertia. Various aspects of scan mirror inertia optimization are reviewed by Ehrmann in “Inertia-optimized mirror geometry and compound imaging optics for precision laser scanning”, SPIE proceedings 3482. The paper reviews various mirror geometries and considers pupil-corrected systems for single scan origin scanning. Pupil correction (e.g. Goldman U.S. Pat. No. 4,685,775) does not minimize both mirrors' inertia, but an optical relay system for example 200 as shown in FIG. 2, images the first scan vertex (e.g. x-axis scan) onto the second scan vertex (e.g. y-axis scan) and can be used to minimize and balance mirror inertias for high speed multi-axis scanning by minimizing the beam footprint on each mirror surface.

With a reimaged scan pupil, the scan vertex of each scan axis can be located at the entrance pupil of a scan lens, and the entrance pupil distance from the first scan vertex to the scan lens pupil can be reduced. Consequently, clear apertures of scan lenses placed after the deflection scan system can be reduced for cost savings and performance improvement when compared to conventional non-relayed scan head. Several types of optical relay are known including refractive, reflective and catadioptric systems. Generally, relay optical systems are large and/or complex and some require a beam waist to be located on a reflective optical surface, while others require corrective optical elements in the relay. When high-power laser sources are used, images on damage prone optical surfaces and losses and reflections associated with additional optical elements are undesirable.

In some scanning applications, telecentric scanning is desirable. In a telecentric system, beam incidence is maintained near normal over the scan field. When there is separation between scan vertices as is the case with typical scan heads, true telecentric scanning is not possible without some form of pupil correction. As part of a deflection system, an optical relay can be used to achieve true telecentric scanning without the increased mirror size associated with either Goldman's pupil corrector or with the so called “paddle scanner” mirror geometry.

Improved high-speed laser scanning systems and methods are desirable to provide simple and compact scanning optical systems with small footprints, high power handling capacity, low mirror inertia, telecentric scanning capability, and non-planar surface focusing capability.

### BRIEF SUMMARY OF THE INVENTION

The present invention is directed to laser scanning systems and methods in which a beam is deflected from first and second superimposed scan vertices. An optical relay images the first scan vertex onto the second scan vertex. The optical relay receives an intermediate image at an internal conjugate and reimages the intermediate image to an external image conjugate. The intermediate image lies on a scanned arcuate locus between the first scan vertex and the optical relay. The external conjugate may be a finite conjugate imaged directly by the optical relay, or indirectly from an infinite external conjugate and an external scan lens. The intermediate image may be formed with a converging optic configured to correct aberrations of the optical relay. The converging optic may include an anamorphic aspheric surface. The converging optic may include an off-axis anamorphic aspheric surface. The converging optic may be translated along a beam axis by translating the intermediate image to change the external image conjugate for field flattening and volumetric scanning.

Various objects, features, aspects, and advantages of the present invention will become more apparent from the following detailed description of preferred embodiments of the invention, along with the accompanying drawings.

### BRIEF DESCRIPTION THE DRAWINGS:

FIG. 1A is 3-dimensional view of pre-objective scanning (prior art);

FIG. 1B is 3-dimensional view of post-objective scanning (prior art);

FIG. 2 is a diagram that illustrates relay imaging (prior art);

FIG. 3 is a diagram that illustrates aspects of a scanning system;

FIG. 4A-4C are views showing aspects of an orthogonally configured embodiment;

FIG. 5 is a view showing reduced incidence at a first scan mirror;

FIG. 6 is a view showing elevation at a first scan mirror in an orthogonally configured embodiment;

FIG. 7 is a view showing aspects of an embodiment with low mirror inertia and a folded input;

FIG. 8 is a view showing aspects of a converging optic;

FIG. 9 is a view showing aspects of an embodiment with a flat-field lens;

FIG. 10 is a diagram that illustrates scanning at multiple levels;

FIG. 11 is a diagram that illustrates scanning a surface contour;

FIG. 12 is a diagram that illustrates scanning at sequential layers;

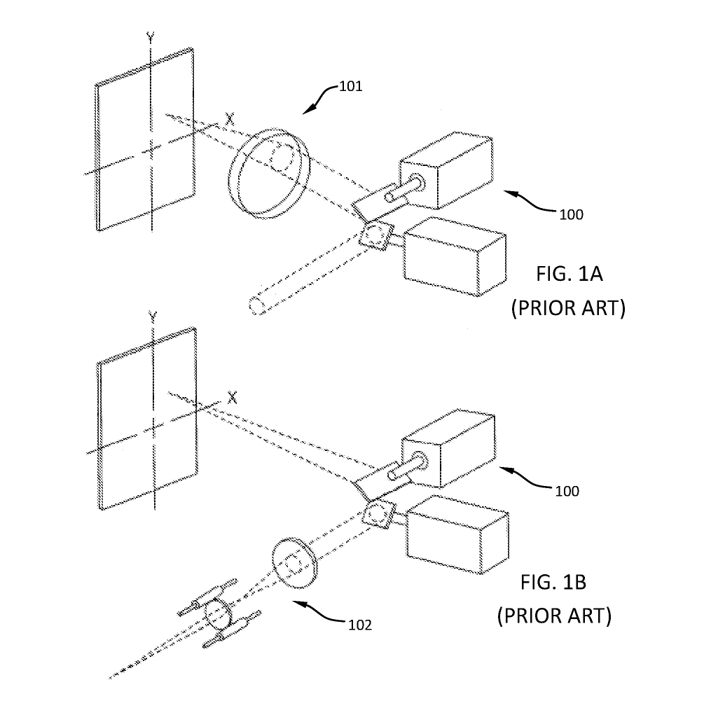

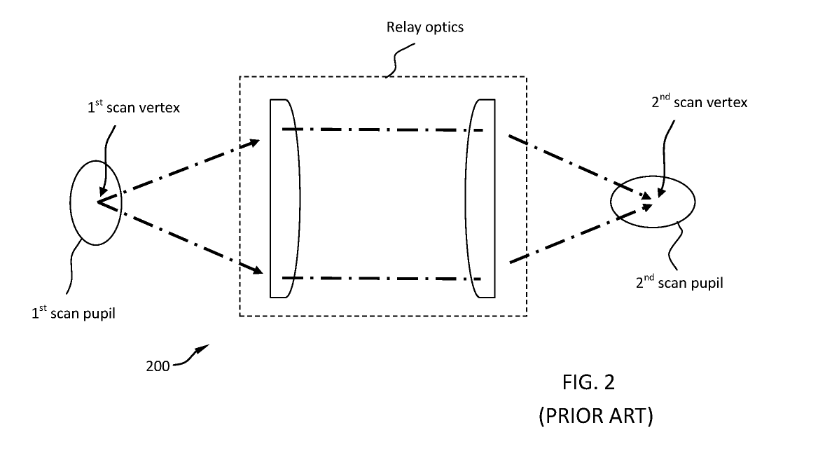

### DETAILED DESCRIPTION OF THE INVENTION

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

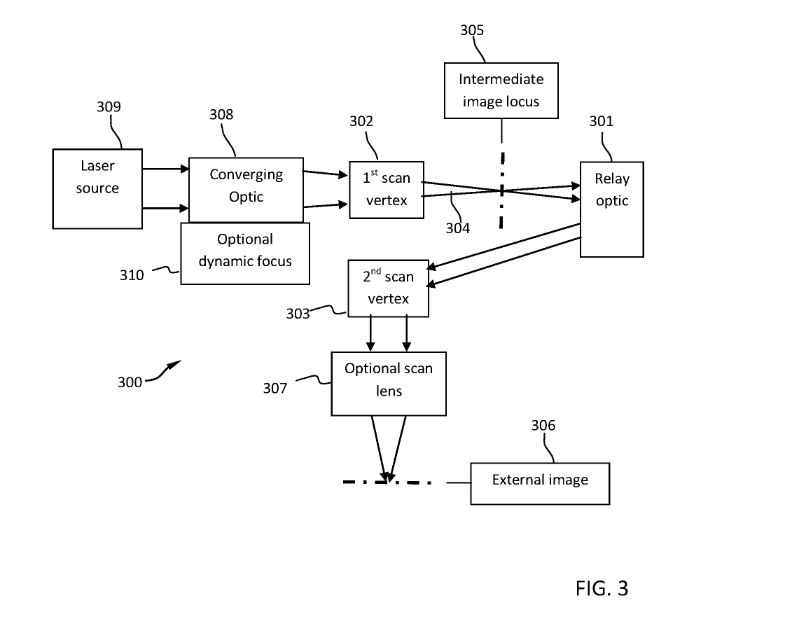

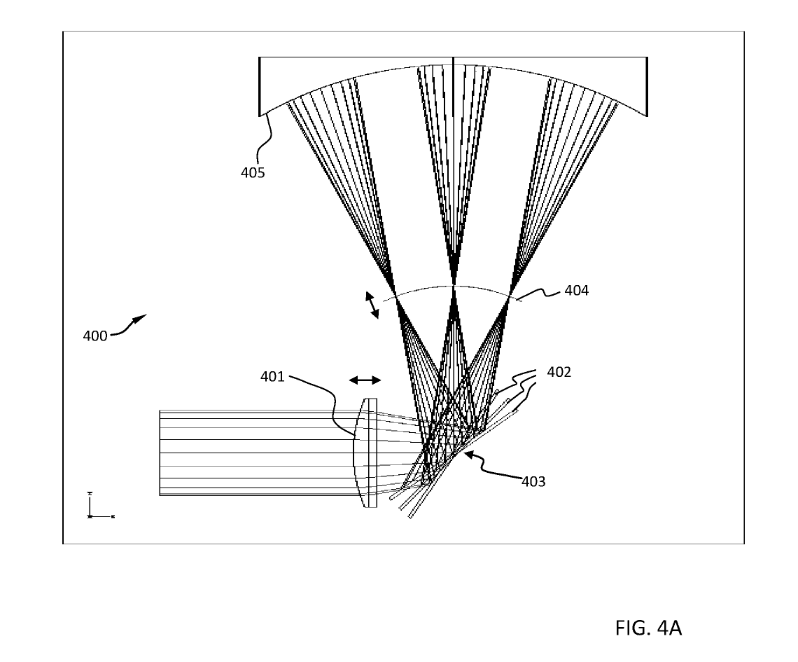

Referring now to FIG. 3, in at least one embodiment of a system 300 of the present invention, relay optic 301 images first scan vertex 302 onto second scan vertex 303. The relay optic also receives and refocuses a converging input beam 304 having an intermediate image locus 305 between the first scan vertex and the relay optic. The relay optic may collimate the converging input beam and focus to an external image 306 with optical scan lens 307, or may reimage the internal intermediate image at a finite conjugate distance directly to an external image. Among many advantages, the relay optical system of the present invention eliminates many adverse effects of conventional non-relayed scan heads and undesirable features of prior optical relay-based scanning systems.

In at least one embodiment, converging input optic 308 receives the input beam from laser source 309 and converges the input to the intermediate image locus. The intermediate image at the locus (e.g. beam waist, source image, fiber core image) is located between the first scan vertex and the first optical surface of the relay optic. The converging optic may provide a variable internal intermediate image conjugate distance from the locus to the relay surface, for example in conjunction with a dynamic focus system 310. When the intermediate image conjugate distance varies, the external conjugate distance varies accordingly to focus the scanned spot at a predetermined distance.

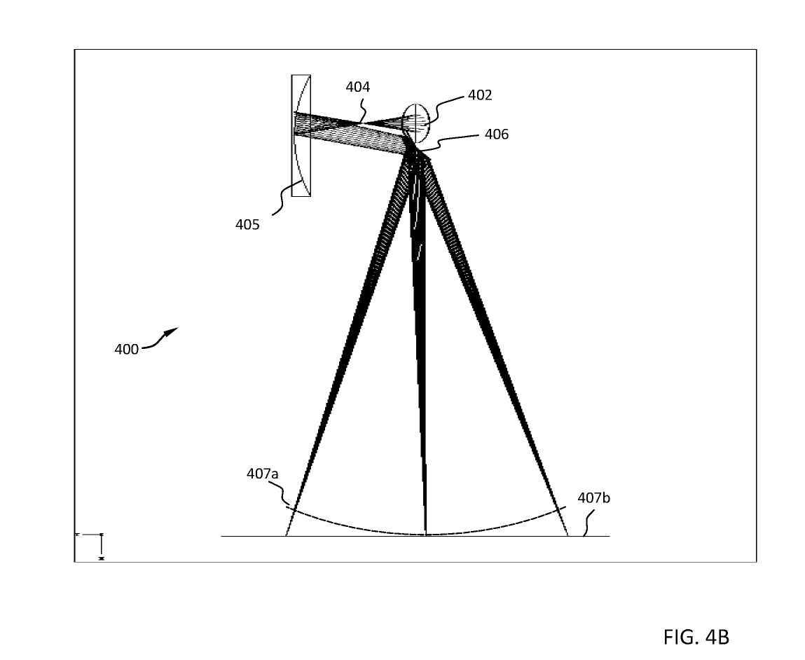

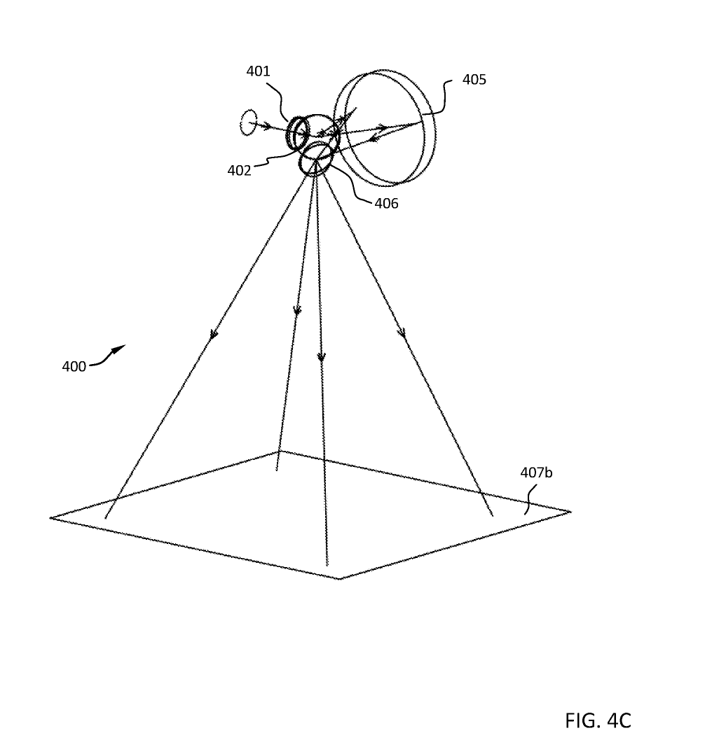

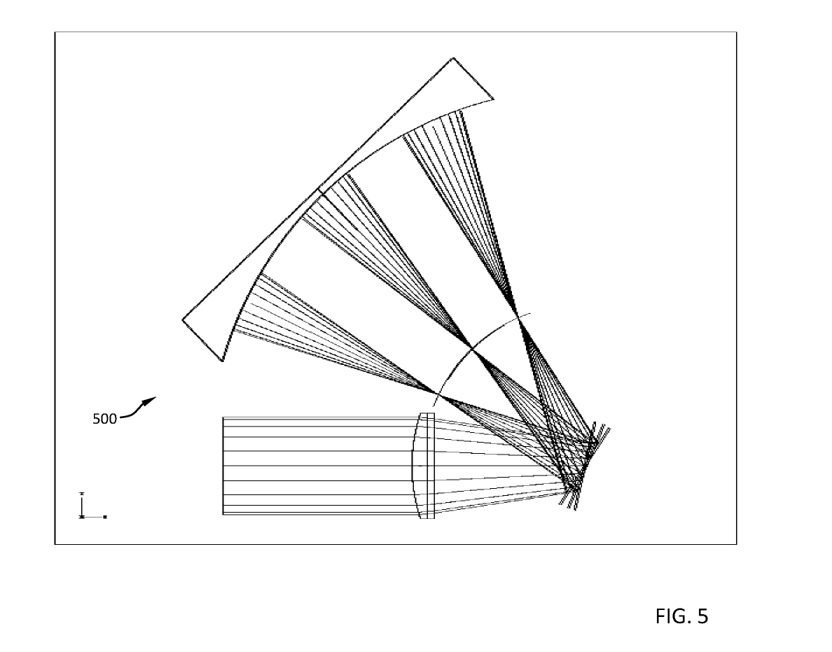

Referring now to FIG. 4A, FIG. 4B, and FIG. 4C, in at least one embodiment of a system 400, a converging optic 401 may be adjustable in responsive to a focus command signal to provide dynamic focus control. The converging input beam impinges the first scan mirror 402 at the first scan pupil and is reflected by the first scan mirror. The first scan mirror is rotated about an axis and the reflected beam is swept at multiple scan angles in a first scan axis from scan first vertex 403. Generally, the rotation axis is perpendicular to the axis of the relay optic. The reflected beam may be perpendicular to the rotation axis with a zero elevation angle such that the scanned beam is swept in a plane. When the reflected beam is not perpendicular, with a non-zero elevation to the rotation axis, the beam may sweep a conical shape.

The first scan mirror is generally a first surface planar mirror parallel to the rotation axis designed for low inertia, but other geometries with tilted mirrors, multi-faceted mirrors, etc. are possible and are contemplated for use in the present invention. The mirror substrate can be glass, fused silica, machined metal (e.g. aluminum or beryllium), cast or etched material, or other suitable mirror substrate material that can receive a flat surface (e.g. <¼ wave optical path difference) within predetermined tolerance limits. The mirror surface may be polished and directly coated to enhance reflectivity at one or more wavelengths with thin film coatings, or reflective surfaces may be applied using optical replication techniques. As shown in FIG. 4B, the first scan mirror and scan vertex may be offset to avoid physical interference with the second scan mirror. Preferably, the offset is a lateral relative to the relay optic imaging axis, and parallel to the scan mirror rotation axis.

As the first scan mirror rotates, the intermediate image is scanned along an arcuate locus 404 that is concentric with both the first scan vertex and the relay mirror surface 405. In this concentric arrangement, relay imaging properties are maintained as the first scan mirror deflects the input beam in a range of scan angles. The arcuate locus lies in a plane that is perpendicular to the rotation axis of the mirror. For non-zero input beam elevation angles relative to the first mirror rotation axis, this plane may be offset from the scan vertex.

The simplest relay optic contemplated is a single a spherical relay mirror having a radius R. The first and second scan vertices are located approximately at a distance R from the relay mirror and the scan vertex and pupil of the first scan mirror are reimaged by the spherical relay mirror onto the second scan mirror 406. Preferably the relay magnification is 1:1 so that the first and second scan pupils are equal size.

Spherical mirrors are readily available and the relay mirror may be a commercially available mirror appropriately coated according to the input beam wavelength(s) and power. Preferably, the relay mirror is a first surface mirror on a glass substrate, but other mirror substrate materials and mirror constructions as previously described are possible.

A shorter mirror radius can be used to configure a very compact optical system, but practical limits for mechanical packaging and optical performance must be considered. For example, the input convergence angle may increase as mirror radius decreases, increasing the need for aberration correction to maintain optical performance. Conveniently, a first surface spherical mirror may be mounted kinematically to provide fine alignment relative to predetermined first and second scan mirror axes.

The relay mirror reimages the scanned intermediate image locus to an external image. Since this locus is concentric with the spherical relay mirror surface, the distance along the beam axis from the intermediate image to the surface of the relay mirror is constant through a range of scan angles. Thus, the intermediate image conjugate distance to the relay mirror is constant and the reimaging magnification of the intermediate image to an external image by the relay mirror is constant when converging optic focus is fixed. So, the concentric intermediate image locus provides reimaging that is independent from first axis scanning. For example, with the intermediate image conjugate distance at the front focal surface of the relay mirror, collimated output (infinite magnification) is maintained as the first scan mirror deflects the input beam axis in a range of scan angles.

When the intermediate image conjugate distance is larger than the front focal length, there is a fixed magnification and the output focus is maintained at a corresponding external image conjugate distance. Since the first and second scan vertices are superimposed, without dynamic focusing or a flat-field lens, the external image is scanned on spherical surface 407a. This is in contrast to a non-relayed and uncompensated scan head where a fixed focus beam is scanned on an elliptical surface because of mirror to mirror separation. When dynamic focusing or a flat-field lens is used, external image field 407b can be flat.

Generally the second scan mirror will be a planar first surface mirror; however like the first scan mirror, and as previously described, other arrangements are possible. The second scan mirror deflects the beam to scan the beam along a second scan axis and the rotation axis of the second mirror is generally orthogonal to both the rotation axis of the first scan mirror and the relay optic axis. The second mirror and scan vertex may be laterally offset relative to the axis of the relay optic corresponding to the lateral magnification of the relay system (i.e. equal and opposite to a lateral offset of the first scan vertex when relay magnification is 1:1). Unlike the offset of the first scan mirror, the second scan mirror offset is generally perpendicular to its axis of rotation.

In at least one embodiment, the first scan mirror and the second scan mirror are each mounted to a respective galvanometer that is in turn mounted in a scan head structure. The relay mirror and converging optic are mechanically coupled to the scan head structure. The galvanometers are driven with suitable drivers and controlled with a controller and system software to provide 2-axis scanning, and when dynamic adjustment of the intermediate image locus is provided, 3-axis scanning. Suitable galvanometers, drivers, controllers and control software are available from Cambridge Technology, Scanlab, Nutfield Technology and other suppliers.

It will be appreciated that scan head controllers provide Cartesian coordinate scanning by applying digital distortion corrections to positioning drive signals. The corrected signals provide correspondence between commanded positions and locations in a scan field. Distortion corrections needed to scan in a Cartesian coordinate system for embodiments of the present invention can be derived geometrically or by ray tracing methods using the relative orientations of the input beam axis and the first scan mirror, the first scan mirror and relay mirror, relay mirror and the and second scan mirror, and the second scan mirror and the scan field. Correction values may be stored in a correction look-up table and accessed to generate Cartesian coordinate positioning commands.

The present invention includes a range of embodiments with different geometrical and optical configurations. Parameters that are considered to be part of the configuration include the laser wavelength and power, input beam diameter, the f/number of convergence of the input beam, the scan pupil diameter, the cone angle of the first scan, the scan range and extreme deflection angle values of the first scan mirror, the focal length of the relay mirror, the cone angle of reception of the second scan mirror, the scan range and extreme deflection angle values of the first second mirror, external image conjugate distance, dynamic focus range, focal length of flat-field scan lenses, focus range of dynamically focused flat-field lenses, spot size, and spot quality.

With regard to geometrical considerations, both azimuth and elevation of the input beam relative to the first scan mirror axis of rotation can be configured in different embodiments of the invention. The elevation angle may be configured so that the beam reflected off the spherical relay mirror is received in a plane converging on the pupil of the second scan mirror. This geometry will substantially duplicate scan angles typical of conventional non-relayed scan heads with a planar scan from the first scan axis. However, a conical input to the second scan mirror is within the scope of the present invention and digital correction can be used to correct Cartesian scan field coordinate errors such as curved scan line artifacts. For example, if the elevation to the first scan mirror is zero with an input beam orthogonal to the first rotation axis, there will be a conical input to the second scan pupil.

The azimuth angle of the input beam to the first scan axis may be 90 degrees relative to the axis of the relay optic with 45 degree incidence to the scan mirror surface at the center of the scan field range. As show in FIG. 5, in modified arrangement of first axis scanning 500, the azimuth angle on the first scan mirror may be reduced below 45 degrees. Optical clearance of the scanned beam and input converging optics may limit the extreme scan angle and center field azimuth angle. Indeed, the azimuth angle may be zero (at the center of the scanning range) when elevation is sufficient for the input beam and converging optic to clear the relay mirror. In this case, considering the elevation angle, the center field angle of incidence may be less than 15 degrees. The center field angle of incidence may approach 0.5 arcsin ((input beam optic diameter)/(relay mirror radius)).

With reduced azimuth angle of the input beam to the first scan axis, the beam footprint on the first mirror can be reduced. The first scan mirror optical footprint may have a major diameter less than the pupil diameter divided by the cosine of the sum of 45 degrees plus one quarter of the scan range. When azimuth is reduced to zero, the beam footprint may be close to the pupil beam diameter, for example less than 1.05 times the pupil diameter.

Reducing the azimuth angle is beneficial for several reasons. The beam footprint on the scan mirror is reduced, and as a result mirror inertia can be reduced. It will be appreciated that mirror inertia is a significant contributing factor in dynamic performance, with lowered inertia increasing scanning performance. As the major axis of the footprint is reduced, the mirror substrate major axis can be reduced and aspect ratio of substrate major axis to thickness can be reduced to improve coated mirror flatness. Furthermore, without increasing mirror inertia, mirror thickness can be increased which can up-shift or diminish mechanical mirror resonance phenomena to improve dynamic servo performance.

Significantly, reduced azimuth angle reduces the maximum angle of incidence of the converging input to the first mirror which can improve mirror coating performance. Mirror coating performance can degrade with high angles of incidence typical of conventional scan head geometry, especially when considering polarization effects. For example angles greater than 45 degrees, mirror reflectivity can be compromised leading to throughput losses and absorption increases in mirror substrates. At low angles of incidence thin film stack height can be reduced, simplifying coatings and reducing induced stresses that can warp mirror surfaces. In at least on embodiment, the maximum angle of incidence is less than 45 degrees.

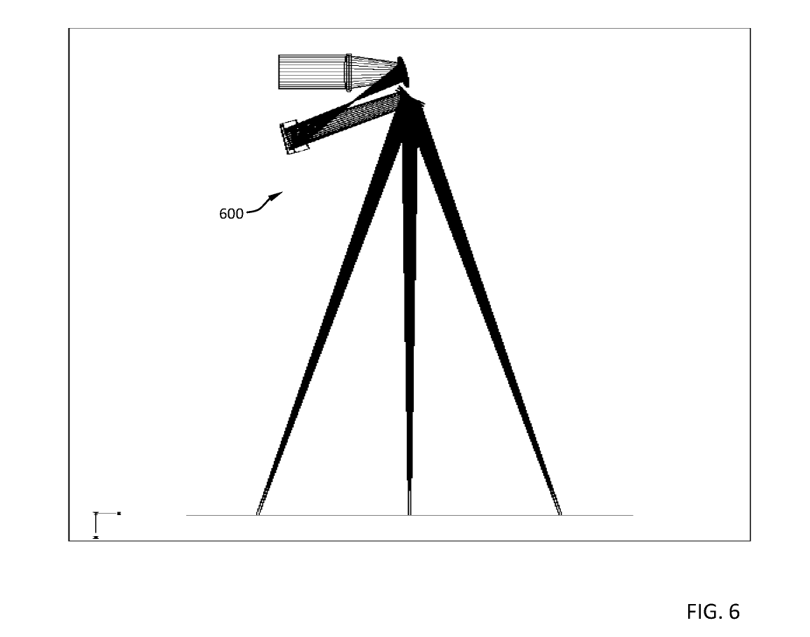

Azimuth of the second scan mirror necessarily accommodates the relayed elevation of the first scan mirror and the scan field location. Azimuth may be further adapted to reduce the azimuth angle and the second mirror inertia with a corresponding rotation of the relay system 600 about the rotation axis of the second scan mirror for example as shown in FIG. 6. In this orientation, the input scan to the second mirror can be planar and the center field azimuth of the second mirror is reduced by rotating the relay system relative to the scan field so the output can be orthogonal to input with low mirror inertias. Additional benefits described with regard to first mirror azimuth can be applied to the second mirror.

In addition, it is important to note that in a relay-based system, there is no beam walk-off on the second mirror since the scan vertices are superimposed. In conventional scan head geometry, beam walk-off lengthens the second mirror (usually referred to as the y-mirror) along the axis of rotation which significantly increases mirror inertia. In the present invention, second mirror inertia, without walk-off lengthening, can be reduced by more than 50% compared with a conventional walk-off design. In particular, a shortened mirror has superior resonance characteristics. Moreover, mismatch of inertia between scan mirrors can be reduced or eliminated so that dynamics in x and y scan axes can be matched for superior performance.

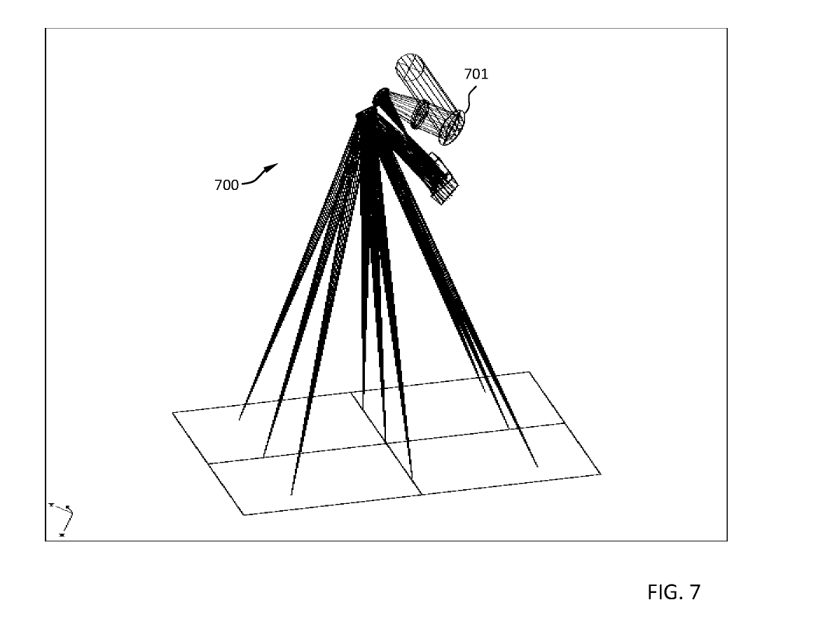

Configuration of different azimuth and elevation angles is desirable to minimize mirror inertia and configure a compact scan head arrangement. But, as result input and output may not be orthogonal, and one or more turning mirrors may be used to provide a desired relative orientation of the input axis and the center field output axis. Referring to FIG. 7, relay system 700 is rotated beyond orthogonal. The second scan mirror optical footprint may have an axial length less than the 2 times the pupil diameter and a cross-axis width less than 1.4 times pupil diameter. For example, axial length may be less than 1.05 times the pupil diameter and the cross axis width may be less than 1.25 times the pupil diameter. In this geometry, a folding mirror 701 can be added to the input to accommodate an orthogonal input beam axis parallel to the scan field.

With regard to optical system configurations and optical performance, it will be appreciated that focused laser spot size is generally of paramount interest in laser scanning applications. Preferably relay-based scan head embodiments are diffraction limited for generating small uniform spots. A relay-based scan head may generate laser spots with Strehl ratios of 0.7 or higher at positions across the scan field. Other criteria may include wavefront OPD of less than ¼ wave peak-to-peak or OPD less than 0.07 waves RMS. Some applications may require even higher levels of correction for example 0.05 waves RMS.

For example, diffraction limited performance at or below ¼ wave of wavefront error, may be required with low order and TEM₀₀ sources. Multi-mode sources and large diameter fiber cores may have less stringent requirements. In a first surface spherical relay mirror system, the sphere will generate well-known optical aberrations. Without any correction, the input beam should be fairly slow, for example greater than f/6 or preferably f/10, to limit the contribution of optical aberrations.

However, a high f/no will increase system foot print by increasing the radius and diameter of the relay mirror. For example, with a 10 mm first scan mirror pupil with a convergence of f/10 the intermediate image would be approximately 100 mm from the first scan mirror and the relay mirror would have a radius of approximately 200 mm and a diameter of approximately 160 mm. In contrast, with aberration correction a compact system can be configured with a faster convergence and a small relay mirror radius. For example, the converging input may be faster than f/3.5. In at least one embodiment, an f/2.5 converging input is received by a 10 mm scan pupil and a 50 mm radius relay mirror.

Techniques used to correct spherical mirror aberrations include additional correction elements such as the Bouwers concentric corrector or more complicated multi-surface mirror arrangements where an intermediate image is located on a mirror surface. In contrast, the present invention eliminates concentric corrective elements and secondary image surface mirrors and yet provides correction for relay mirror optical aberrations.

In at least one embodiment, aberration correction is provided upstream of the relay optic in the input converging optical system without correcting elements in the relay system between the first and second scan mirrors. Because the scanned intermediate image is concentric with the spherical relay mirror, upstream aberration corrections are applied uniformly through the scan range of the first scan mirror.

In at least one embodiment, the converging optic is corrected for spherical aberration and the relay mirror aberration is corrected with weak cylindrical power in the converging optic. Improved correction for the relay mirror is achieved with a wedge element in the converging beam. The cylinder power or cylinder plus wedge correction can be applied in different ways. With spherical surfaces, a stack of positive elements and a weak cylinder lens element can be used, optionally an optical wedge element. This spherical surface approach results in many optical surfaces, for example with three spherical elements, cylinder and wedge there would be ten surfaces.

Other arrangements are possible to provide correction. For example, the converging optic may comprise multiple elements, including at least one element having negative optical power. Element decentration and tilt may be used in addition to or in place of a wedge element. The converging optic may include four elements, a first group comprising two elements of a Cooke triplet displaced laterally toward the axis of the relay optic and a second non-displaced group comprising the third element of the Cooke triplet and a weak cylinder element.

The surface count of the converging optic can be reduced with a single aspheric element that provides the spherical power in place of the spherical stack. With an anamorphic asphere, the power of the cylinder element can also be consolidated with the asphere. For example, an aspheric element may have a first aspheric surface and a second cylindrical surface. Alternatively, the asphere may comprise a biconic surface that corrects spherical aberration and adds the cylindrical power. Other anamorphic asphere surface forms may be used, for example a conic surface with added x or y polynomial coefficients (e.g. x², y²), added Zernike cylinder coefficients, or any other aspheric surface prescription that converges the input beam with both aspheric correction and cylindrical power.

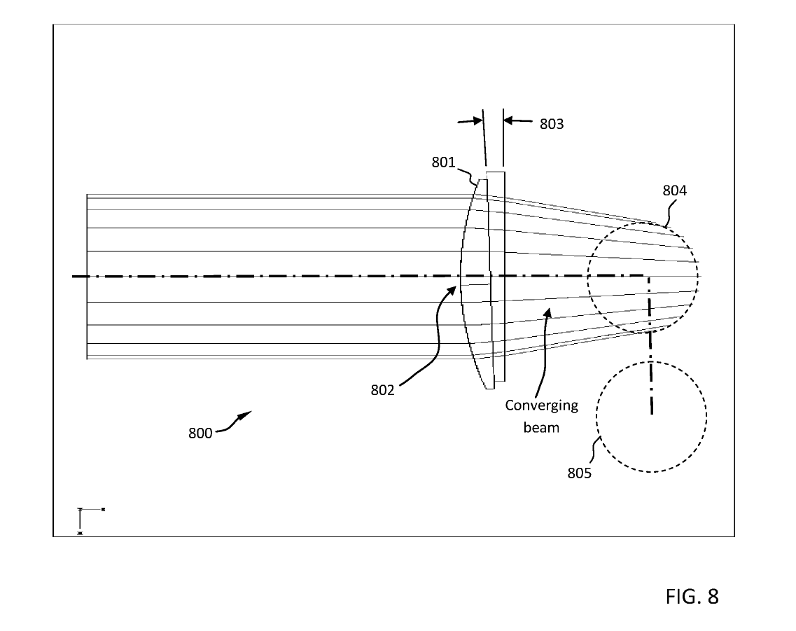

The upstream converging optic can be reduced to a single optical element by consolidating the wedge into the asphere with a tilt and decenter. Referring to FIG. 8, in at least one embodiment converging optic 800 comprises a single anamorphic aspheric converging input element. For clarity, the element is depicted as a doublet construction but the internal plano interface can be eliminated in a singlet construction. A first decentered and tilted biconic surface 801 corrects relay system optical aberrations. The biconic vertex 802 is rolled a small amount about a base sphere to provide the optical wedge 803. The wedge may be oriented as shown relative first scan pupil 804 and second scan pupil 805. Aspheric parameters, x and y radius, x and y conic constant, vertex decenter and vertex tilt are readily optimized in a ray tracing model of the optical system with commercial optical design software. Preferably, the second surface is a plano surface to facilitate fabrication. Conveniently, with the aspheric roll, wedge can be introduced without beam deviation from the input optical axis.

The converging optic may be fabricated from any optical material with suitable transmission and fabrication properties such as BK7 glass, fused silica, or high index glass (e.g. SFL6). Additionally, for infrared applications, elements may be fabricated from higher index infrared materials like ZnSe and Ge.

The smallest achievable converging optic f number may be limited by asphere production and measurement techniques. For example, departure of an aspheric surface from a best fit sphere with regards to waves per millimeter may be limited by minimum polishing tool contact area. With higher index of refraction, aberrations and spherical departure of an aspheric surface can be reduced. Therefore, for a predetermined level of optical correction, lower f numbers may be possible using higher optical index materials for the converging optic.

In at least one embodiment, the converging input optic is dynamically translated along the input optical axis to change the internal conjugate distance, from the intermediate image to the relay mirror, and controllably adjust the external conjugate distance from the relay mirror to the external focus. For example, changing internal conjugate distance can be used to flatten a curved scan field and more generally, to focus on contoured surface.

In other embodiments, the internal conjugate distance may be changed with auxiliary variable elements without translating the converging optic. For example a variable input beam divergence or variable power optical element may change the internal conjugate distance. Auxiliary variable elements may include upstream lens translators, fluid lenses and the like.

In a compact relay system with a small relay mirror radius, the focal length of the relay, R/2, is short. This short focal length means that the axial magnification, also known as the optical leveraging ratio, will be large. Small changes in the intermediate image axial position may be controlled with a short stoke precision actuator used to move the converging optic. Positioning resolution and stability of the converging optic should be considered with respect to laser spot size, spot positioning tolerances and spot depth of focus.

The following table shows some contemplated system parameters with a 50 mm radius relay mirror, +−20 degree optical scan angles, and an optimized dynamic converging optic for a 1064 nm laser to focus on a workpiece without an external flat-field lens or cover glass. In the first row, scan radii (second scan mirror to flat field) are 50 mm to 500 mm, with field sizes range from 50 mm to 500 mm or more shown in the second row. The third row titled Defocus represents an additional diffraction limited focus range from a nominal flat-field focus at the listed scan radius. The final row titled Flat/full z shows the travel range of the converging optic over a nominal flat field and over full range including flat-field defocus. Performance may be reduced when a scan head cover glass is used, particularly for the shortest scan radii with thick windows.

| | | | | | | |
|---|---|---|---|---|---|---|
| Scan | 50 | 75 | 100 | 160 | 254 | 500 |
| radius | | | | | | |
| Field | 35 | 53 | 71 | 114 | 180 | 355 |
| Size | | | | | | |
| De- | −.5/+2 | −4/+7 | −9/+15 | −29/+50 | −69/+196 | −225/+5500 |
| focus | | | | | | |
| Flat/ | .72/.97 | .61/1.24 | .52/1.39 | .38/1.64 | .26/1.81 | .15/1.99 |
| full z | | | | | | |

All units are in millimeters

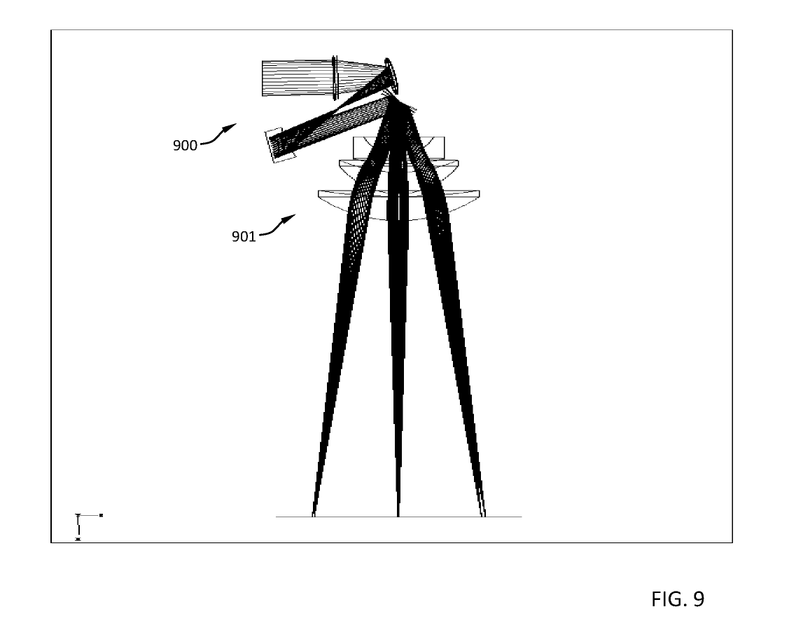

While these examples use dynamic field flattening, faster beam positioning may be possible without translating the converging optic. In at least embodiment, for example relay scanning system 900 as shown in FIG. 9, the scanned beam is collimated or nearly collimated and flat-field lens 901 is used for focusing onto the scan field. With the flat-field lens, beam positioning speed is determined by the scan mirror dynamics. The flat-field lens may be a telecentric lens. Translation of the converging optic can be used in conjunction with the flat-field lens to adjust focal plane height statically or dynamically.

Preferably, scan head deflection angles are +−20 degrees or more optical and scan a laser spot in a square scan field. However, relay-based scan head embodiments may use scan angles less than 20 degrees with square fields or use round field, rectangular field, or other field shape formats to reduce flat-field lens component optical element size, cost and complexity.

In at least one embodiment, a controller is configured to communicate with a scan head or with galvanometer drivers to control laser scanning. The controller generates and transmits galvanometer positioning signals that correspond with scan field positions. The controller may be configured to transform scan field coordinates from a nominal focus height field coordinate system to coordinates in a field corresponding with the adjusted focus height to scan at predetermined coordinates. When dynamic focusing in employed, the controller may be configured to generate and transmit z-axis positioning signals.

Embodiments of the present invention may include scan head control electronics such as electronics commercially available from the galvanometer suppliers previously mentioned. The control electronics may comprise a digital or analog servo driver for each galvanometer and a control command interface (e.g. serial input, 16 bit DAC output) using an access protocol such as a serial or parallel data bus to receive command signals, generate galvo driver inputs and return status signals. One digital protocol used to control scan heads via a serial bus is the XY2-100 protocol. Data transfer protocols with sufficient bandwidth to drive a scan may have data transfer rates of 100 kHz or higher. While digital command signals are preferred, analog signals may be received directly as galvo servo inputs.

A scan controller, generally associated with a scan head, generates scan command signals and may be a host computer, embedded computer, microcontroller or FPGA configured to generate scan control signals. The scan control signals may provide angular galvo coordinates, z-axis positioning coordinates, timing for galvo motion, and may provide laser control signals coordinated with galvo motion. The scan controller may comprise an embedded microcomputer configured to function as a scan controller.

An embedded controller may be configured to store and run scan jobs, and transmit positioning commands to the scan head. For example, scan jobs may be uploaded via XY2-100 protocol or other serial link which may be wired or wireless data links to the controller from a host computer. The controller may store one or more scan jobs in memory and stored jobs may be run on command.

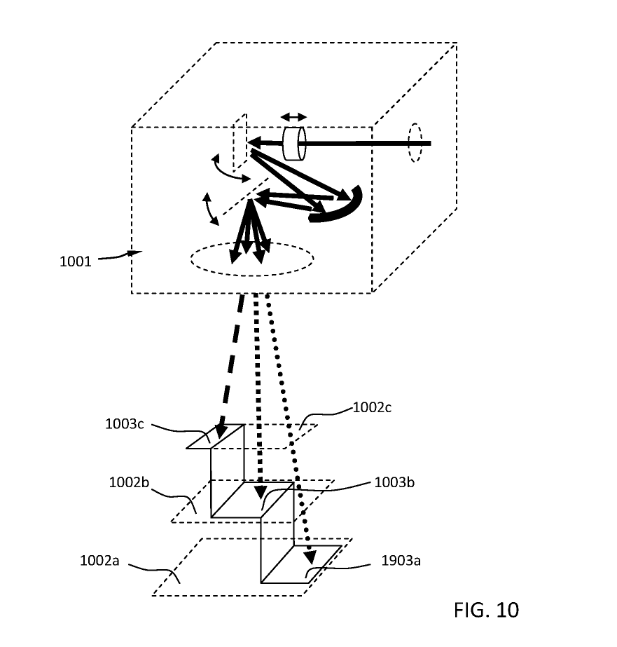

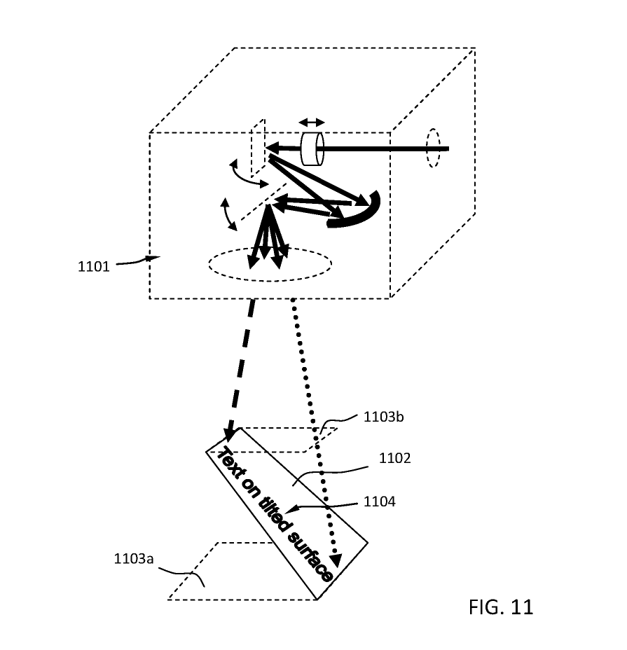

In one example, shown in FIG. 10, scan head 1001 is focused on one or more respective focus steps 1002a, 1002b, 1002c to process material 1003a, 1003b, 1003c at each respective adjusted step. For continuous surfaces, topographic field data may be parsed into discreet focus steps based on available spot depth of focus. Within each step, topographic data can be used for geometric correction of spot position errors resulting from height differences.

Sensed or predetermined topographic data may be used to establish a tilted surface. For example, as shown in FIG. 11, scan head 1101 is focused to automatically track height of the tilted surface 1102 from focus step 1103a, through 1103b. In many applications, scan head dynamic focus range can provide large focus depth. For example, focus tracking may be used in scanning of a tilted surface, or in tracking focus of a text string 1104 on a tilted surface.

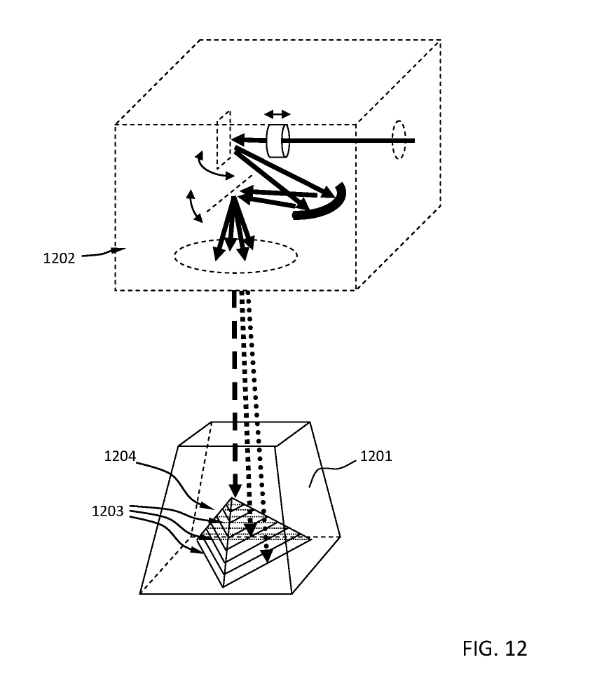

Now with regard to some three dimensional aspects of relay-based scanning and referring to FIG. 12, the angular scan field and focus range of scan head 1202,determines an addressable scan volume that is essentially a truncated pyramid shape 1201 when the scan field is square. Volumetric scanning of objects is possible within this shape on a layer by layer basis by incrementing the focus of scan head 1202, for example layers 1203 of tetrahedron 1204. This type of processing might be used for example in an additive manufacturing process adding layers of photopolymer to a stationary article. With volumetric processing it may be desirable to control spot size by adjusting the beam diameter as discussed above. For example, at any processing layer within the processing volume, an adjusted beam diameter can be used to equalize the spot size from the bottom to the top of the processing volume.

Embodiments of the present invention may be used in many industrial and non-industrial laser scanning applications. For example, without limiting the scope of the invention, applications may include laser marking, contour marking, laser micromachining, and laser material processing. Applications may also include laser scanned medical procedures, scanned laser metrology, laser projection, or any laser scanning application that can benefit from fast compact relay-based scan heads and relay-based dynamic focusing scan heads.

Thus, specific compositions and methods of high-speed optical scanning have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A laser scan head configured to receive an input beam and direct the input to a scanned output beam in at least two scanned axes from a single scan origin, the scan head comprising:
a first beam deflector having a clear aperture that accommodates a converging input beam, the first deflector configured to scan an image associated with the converging input beam along an arcuate intermediate image locus associated with a first output beam scan axis,
a second beam deflector having a clear aperture that accommodates an image of the clear aperture of the first beam deflector, the second deflector configured to scan the output beam along a second scan axis,
a relay optic configured to image the clear aperture of the first deflector to the second deflector, to receive the arcuate intermediate image locus at an internal conjugate distance, and to reimage the intermediate image from the internal conjugate distance to an external conjugate distance, and
a scan head structure coupled to the first deflector, the second deflector and the relay optic.

2. The laser scan head as in claim 1, wherein the first deflector comprises a first scan mirror mounted to a first galvanometer scanner and a second scan mirror mounted to a second galvanometer scanner.

3. The laser scan head as in claim 1, wherein the relay optic is a spherical mirror.

4. The laser scan head as in claim 1, wherein the internal conjugate distant is greater than the focal length of the relay optic, whereby the external conjugate is a finite conjugate distance.

5. The laser scan head as in claim 1, further comprising a scan lens configured to receive the scanned output, whereby the external conjugate distant corresponds to the back focus of the scan lens.

6. The laser scan head as in claim 1, further comprising a converging optic configured to receive an input beam and converge the input beam, the converging input beam forming an image at the intermediate image locus.

7. The laser scan head as in claim 6, wherein the converging optic provides aberration correction for the relay optic.

8. The laser scan head as in claim 7, wherein a first optical surface of the converging optic comprises an anamorphic aspheric surface.

9. The laser scan head as in claim 7, wherein the converging optic provides cylindrical power and an optical wedge.

10. The laser scan head as in claim 7, wherein a first optical surface of the converging optic comprises an off-axis anamorphic aspheric surface.

11. The laser scan head as in claim 7, further comprising translating means to move the converging optic along the input beam axis to change the radius of the intermediate image locus, to vary the internal conjugate distance and vary the external conjugate distance.

12. The laser scan head as in claim 1, further comprising a control signal interface for receiving at least one control signal that corresponds to a position in a scan field.

13. The laser scan head as in claim 1, wherein the first and second beam deflectors comprise respective first and second scan mirrors with respective maximum incident beam angles less than 45 degrees.

14. The laser scan head as in claim 1, wherein the second beam deflector comprises a second scan mirror and the length of second scan mirror along its rotational axis is less than its cross-axis width.

15. The laser scan head as in claim 1, wherein the first and second beam deflectors comprise respective scan mirrors with respective mirror inertias, wherein the second mirror inertia is less than 2 times the inertia of the first scan mirror.

16. The laser scan head as in claim 1, wherein the first and second beam deflectors comprise respective scan mirrors with respective mirror inertias, rotated by respective galvanometers, wherein the galvanometer rotor inertias are each less than 2 times the inertia of the first scan mirror

17. A relay scan head based beam directing system comprising:
a dynamic converging lens responsive to scanning commands configured to receive an input beam, converge the input beam, and controllably focus the beam to an intermediate image,
a first beam deflector responsive to scanning commands configured to receive a converging input beam and deflect the input at scan angles corresponding to first axis locations in a scan field,
a relay mirror configured to refocus the converging input and reimage the intermediate image to the scan field at a controlled external conjugate,
a second beam deflector responsive to scanning commands configured deflect the refocused beam at scan angles corresponding to second axis locations in the scan field, and
a controller configured to generate scanning commands for the dynamic converging lens, the first beam deflector, and the second beam deflector to direct and focus the scanned beam to predetermined points in the scan field.

18. The relay scan head based beam directing system as in claim 17, wherein the controller is responsive to focus adjustments and configured to output scanning commands that direct the scanned beam to predetermined points in the scan field at multiple focus height settings.

19. In a laser processing system comprising a laser source, a relay-based three axis beam deflector responsive to three dimensional scanning commands, and a material handling system for locating a workpiece relative to a laser processing scan volume, a laser processing method comprising:
processing material in the scan volume field at a first focus height, and
processing material at a second focus height.

20. The method as in claim 19, further comprising sequentially focusing the scan head at multiple workpiece heights in the scan volume and processing workpiece material at the multiple heights.
